(19) United States
(12) Patent Application Publication
(10) Pub. No.: US 2010/0013671 A1
(43) Pub. Date: Jan. 21, 2010

(54) Lighting apparatus with integrated warning equipment and data collection equipment

(76) Inventor: Massimo Fucci, Alessandria (IT)

Correspondence Address: Massimo Fucci, Via Trotti, 52, Alessandria, 15100, IT

(21) Appl. No.: 11/650,621

(22) PCT Filed: Jun. 20, 2005
(86) PCT No.: PCT/IT2005/000358

§ 371 Date: Jan. 8, 2007

(30) Foreign Application Priority Data
Jul. 5, 2004 (IT) MI2004U000327

(51) Int. Cl. G08G 1/01; G08B 5/36

(52) U.S. Cl. 340/936; 340/815.67; 348/149

(57) ABSTRACT

A lighting apparatus including an external case (12) containing a lighting source (13), warning equipment (18) and data collection equipment (19), the warning equipment and data collection equipment being situated at least partly inside the above external case and the warning equipment being controlled on the basis of the data collected by the data collection equipment.

### TECHNICAL FIELD

The invention hereunder refers to a lighting apparatus equipped with integrated warning equipment and data collection equipment, to be used (for example) for urban and non-urban traffic control and management or (more in general) for the monitoring of public and private areas (indoor and outdoor). The combined presence of data collection equipment and warning equipment enables the apparatus (among other things) to detect and signal dangerous traffic situations (accidents, queues, icy or slippery road conditions, road works), to monitor access to restricted or private areas, and to measure driving speed, interacting in an intelligent manner with the surrounding environment in which it is installed.

### BACKGROUND ART

Lighting apparatuses—typically in the shape of lampposts—equipped with one or more warning devices in addition to the conventional lighting source are a well-known technical application. The warning equipment normally comprises an auxiliary light source, which may be used to signal, for example, a malfunctioning in the lighting apparatus or even a dangerous situation on the road close to the lamppost. These apparatuses, however, perform a mere warning function and are not capable of interacting with the surrounding environment.

Road-side apparatuses equipped with sensors designed to measure (for example) the speed of passing vehicles are also already known. However, in order to be installed in the proximity of the road, such apparatuses require dedicated support structures and are often plainly visible and at the mercy of all sorts of vandal attacks. They also need a dedicated power supply line, which remarkably increases installation costs.

### DISCLOSURE OF INVENTION

The general purpose of the invention hereunder is to offer a solution to all of the above mentioned difficulties by introducing a lighting apparatus which is also capable of collecting data in order to enable interaction with the surrounding environment.

Another purpose of the invention hereunder is to provide a lighting apparatus which features a compact, integrated, and sufficiently low-cost design.

To achieve the above objectives, the lighting apparatus constructed according to the invention hereunder includes an external case containing the lighting source, warning equipment and data collection equipment, the warning equipment and data collection equipment being situated at least partly inside the above external case and the warning equipment being controlled on the basis of the data collected by the data collection equipment.

### BRIEF DESCRIPTION OF DRAWINGS

In order to clarify the innovative principles inherent in this invention, as well as its advantages to prior art, the following section describes a possible application of such principles, with the aid of the attached figures, where by:

FIG. 1 is a side view of a lighting apparatus constructed according to the invention hereunder,

FIG. 2 is an underside view of the apparatus depicted in FIG. 1.

### BEST MODE FOR CARRYING OUT THE INVENTION

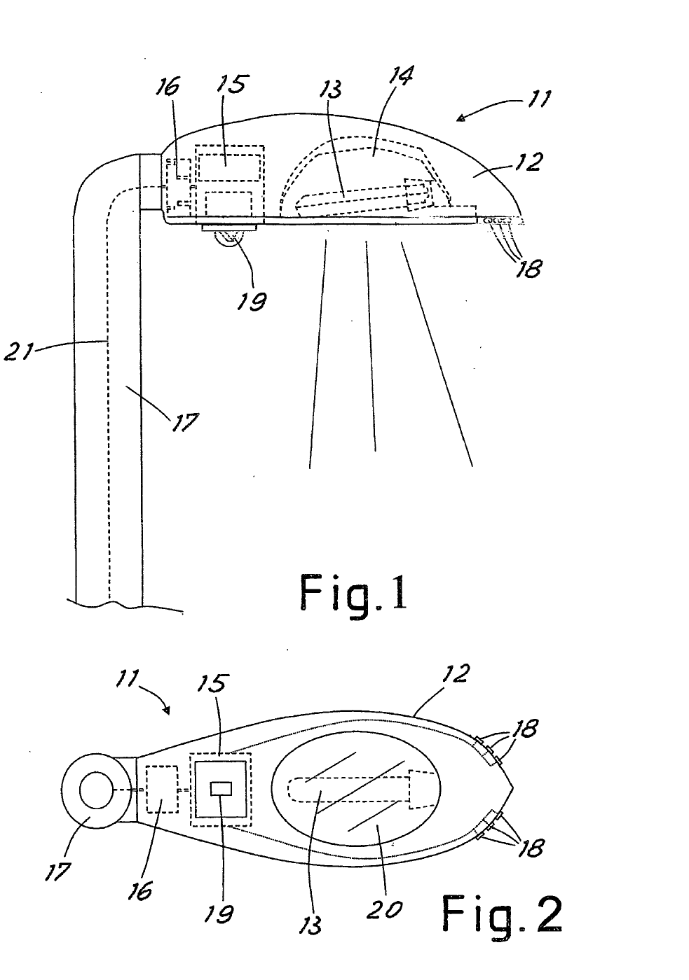

In particular, FIG. 1 shows a side view of a lighting apparatus 11 including an external case 12 containing a lighting source 13.

The external case 12 comprises a halved shell identical to that used for standard lampposts and can be supported by a post 17.

The case 12 also contains a reflector 14 which is shaped to optimise the photometric performances of the light source 13 and which interferes with but improves the efficiency of the processing equipment 15 and the data collection equipment 19, on the basis of known lighting engineering principles.

According to the invention hereunder, the case 12 contains the data collection equipment 19. The data collection equipment 19 could include a cctv camera or, alternatively, a speed sensor (to measure driving speed), an environmental sensor (to measure temperature, humidity, pressure, ice presence, etc.), a doppler radar or other types of sensors.

The lighting apparatus 11 can also be equipped with warning equipment 18, in the form, for example, of warning lights. The warning devices 18 are capable of emitting different colour lights and may be used to inform motorists on traffic, dangerous situations, accidents, icy road conditions, etc. As shown in the figure, the warning devices 18 may be conveniently positioned at the apparatus's front end so that they can be easily seen by motorists and passers-by.

The external case 12 could also contain data processing equipment 15; the processing equipment 15 is connected to the data collection equipment 19 and to the warning equipment 18 and is capable of controlling the warning equipment based on the data collected by the lighting apparatus 11.

The processing unit 15 enables the apparatus to process the information locally and interact in an intelligent manner with the environment.

Note that the processing unit 15, the data collection equipment 19 and the warning equipment 18 may be powered through a supply unit 16. The power supply unit is situated inside the case 12 near the post 17 and can be conveniently connected to the post's electrical cable 21.

In an alternative application of the invention hereunder, the apparatus could be constructed without the processing unit 15. In that case, the data would be transmitted to a remote data processing station, for example through the electrical cable 21 or through another transmission system. This allows to monitor from a remote position the environmental conditions of the area surrounding the lighting apparatus and to centrally control the warnings given by the various apparatuses positioned along the same road. FIG. 2 shows an underside view of the apparatus constructed according to the invention hereunder. Such figure also sketches the connection between the processing unit 15 and the warning equipment 18 at the front end of the external case 12. As commonly seen in prior art, the light source 13 could be sealed with a glass cover 20.

### INDUSTRIAL APPLICABILITY

We can now clearly see how the invention's purposes have been achieved. Indeed, the lighting apparatus constructed according to the invention hereunder allows to combine the data collection function, the warning function and the conventional lighting function (including street lighting) into a single device.

This integrated design makes the apparatus suitable to monitor public or private areas (e.g.: shopping centre indoor and outdoor areas, hotels, underground stations, transport vehicles, etc.) and urban and non-urban road sections, collecting images, sounds or other information, depending on the type of sensor installed on the apparatus.

The data collection equipment can monitor access to restricted areas, measure driving speed and collect environmental data or other information.

Data may be processed locally (through a local processing unit) or remotely (by transmitting the data to a remote processing station). Once the data collected have been processed, they may be used as a basis to control the warning equipment fitted on the apparatus as per the invention hereunder, thus ensuing a high degree of interactivity with the external environment. The warning devices—which may be of visual, sound or other type—can be used to warn users of dangerous road sections, junctions, queues, hold-ups, adverse weather conditions, vehicle exits, schools, etc.

Furthermore, the data collection equipment is barely visible to passers-by and is not at the mercy of vandal attacks. Lastly, the appartus's integrated design allows to make optimal use of existing lamppost support structures, creating compact and low-cost solutions.

Note that the data collection, processing and warning equipment could be built into the lighting apparatus at the time of construction, or, alternatively, the data collection, processing and warning equipment could be installed into an existing lighting apparatus at a later time.

Obviously, the above description of the innovative principles inherent in the invention hereunder constitutes a mere example of how such innovative principles could be applied and shall not be construed as a limitation to the scope of the property rights claimed hereunder.

1. Lighting apparatus including an external case (12) containing a lighting source (13), warning equipment (18) and data collection equipment (19), the warning equipment and data collection equipment being situated at least partly inside the above external case and the warning equipment being controlled on the basis of the data collected by the data collection equipment.

2. Lighting apparatus as per claim 1 whose data collection equipment includes a cctv camera (19).

3. Lighting apparatus as per claim 1 whose data collection equipment includes sensors measuring the speed of vehicles driving along the road lit by the apparatus.

4. Lighting apparatus as per claim 1 whose data collection equipment includes environmental sensors.

5. Lighting apparatus as per claim 1 whose warning equipment (18) includes warning lights in different colours.

6. Lighting apparatus as per claim 1 including processing equipment (15) for the analysis of the data cold by the data collection equipment (19), such processing equipment being situated inside the above external case (12).

7. Lighting apparatus as per claim 1 including transmission equipment suitable to transfer the data collected to a remote data processing station and to control the warning equipment (18) from the remote data processing station.

8. Lighting apparatus as per claim 1 including a power unit (16) situated inside the external case (12) to supply the data collection equipment (19) and warning equipment (18).
